(19) United States
(12) Patent Application Publication
(10) Pub. No.: US 2024/0367140 A1
(43) Pub. Date: Nov. 7, 2024

(54) WASTEWATER ADSORBENT, AND PREPARATION METHOD THEREFOR AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Aixia Li, Foshan, Guangdong (CN); Yinghao Xie, Foshan, Guangdong (CN); Xuemei Zhang, Foshan, Guangdong (CN); Yingsheng Zhong, Foshan, Guangdong (CN); Changdong Li, Foshan, Guangdong (CN)

(21) Appl. No.: 18/681,105

(22) PCT Filed: Jul. 29, 2022
(86) PCT No.: PCT/CN2022/109232

§ 371 Date: Feb. 5, 2024

(30) Foreign Application Priority Data
Oct. 26, 2021 (CN) 202111246459.6

(51) Int. Cl. B01J 20/02; B01J 20/04; B01J 20/20; B01J 20/30; C02F 1/28

(52) U.S. Cl. CPC B01J 20/0225; B01J 20/0222; B01J 20/04; B01J 20/20; B01J 20/3021; B01J 20/3042; B01J 20/3071; C02F 1/283

(57) ABSTRACT

Disclosed in the present invention are a wastewater adsorbent, and a preparation method therefor and the use thereof. The method comprises: mixing a carbon black powder and an ammonium salt solution, heating same for a hydrothermal reaction, followed by filtering, and washing the obtained filter residues with acid to obtain an ammonium-salt-modified carbon black; mixing and grinding a nickel-cobalt-manganese mixed salt and a sodium salt to obtain a mixture, mixing the mixture with an organic acid solution, evaporating same to remove water, subjecting same to a heating reaction in an inert atmosphere, and subjecting the reacted material to acid pickling to obtain a nickel-cobalt-manganese-sodium mixed salt; and mixing the nickel-cobalt-manganese-sodium mixed salt, the ammonium-salt-modified carbon black and a binding agent, and compacting, drying and heating same to obtain a multimetal-carbon-based adsorbent.

### TECHNICAL FIELD

The present disclosure belongs to the technical field of wastewater treatment, and specifically relates to a wastewater adsorbent and a preparation method therefor and use thereof.

### BACKGROUND

At present, ternary cathode material is obtained via synthesis by sintering lithium salt and ternary precursor. The synthesis process of ternary precursor includes the following two types: 1. waste lithium ion battery/electrode plate is disassembled and recycled to obtain battery powder, which is subjected to roasting, acid oxidation leaching, extraction and purification to obtain nickel-cobalt-manganese mixed salt, to which alkali and ammonia are added to obtain ternary precursor products; and 2. various minerals are subjected to acid leaching, precipitation and impurity removal, extraction and purification to obtain nickel salt, cobalt salt and manganese salt respectively, which are used in combination with alkali and ammonia in synthesis to obtain ternary precursor products. Both of the above-mentioned two synthetic processes of ternary precursors inevitably use acid, especially sulfuric acid as leaching agent, alkali as precipitant and regulator, ammonia as complexing agent, and organic extractant to extract nickel, cobalt and manganese metal ions. In order to prevent ammonium salts, sulfates, and organic extractants from remaining in the nickel-cobalt-manganese salt solution, resulting in a higher contents of ammonium salts, sulfates, and organic extractants in the ternary precursor, which exceeds allowable standard of the products, multiple pressure filtration and washing are often used to remove sodium ions. Therefore, on the one hand, a larger amount of pure water is needed to wash out ammonium salts, sulfates, organic extractants and other soluble impurities for multiple times. Water consumption will increase, the production of waste water will increase, and the cost of waste water treatment will increase. On the other hand, with the increase of number of times for washing, the concentration of ammonium salts, sulfates, and organic extractants in the produced wastewater is lower and lower, being difficult to be treated, and deep removal of ammonium salts, sulfates, and organic extractants cannot be performed.

### SUMMARY

The present invention aims to solve at least one of the above-mentioned technical problems existing in prior art. For this reason, the present invention proposes a wastewater adsorbent and its preparation method and application. The first objective is to prepare a wastewater adsorbent, and the second objective is to provide a wastewater treatment method that uses the above-mentioned wastewater treatment agent for deep removal of ammonium salts, sulfates, and organic extractants.

According to one aspect of the present invention, a preparation method for a wastewater adsorbent is proposed, comprising the following steps:

S1: mixing carbon black powder with ammonium salt solution, heating for hydrothermal reaction, and then filtering, washing the resulting filter residue with acid to obtain ammonium salt modified carbon black; mixing and grinding nickel-cobalt-manganese mixed salt and sodium salt to obtain a mixture, mixing the mixture with an organic acid solution, evaporating to remove water, and performing heating reaction in an inert atmosphere; and acid washing a material after the reaction to obtain nickel-cobalt-manganese-sodium mixed salt; and

S2: mixing the nickel-cobalt-manganese-sodium mixed salt, ammonium salt modified carbon black and a binding agent, compacting, drying and heating to obtain a multi-metal-carbon-based adsorbent. The heating in step S2 is carried out under a nitrogen gas atmosphere.

Wherein, after the compacting, a certain shape is obtained, such as a sheet shape, a block shape, a long rod shape, a spherical shape, and an irregular polygon shape.

In some embodiments of the present invention, in step S1, the carbon black powder is obtained by acid oxidation leaching battery powder recovered from a lithium battery. Further, an average particle size of the carbon black powder is less than 0.1 mm.

In some embodiments of the present invention, in step S1, the ammonium salt solution is one or more of ammonium sulfate, ammonium bisulfate, ammonium carbonate, ammonium bicarbonate, ammonium chloride, ammonium phosphate, or ammonium dihydrogen phosphate; preferably, the ammonium salt solution is one or two of ammonium sulfate or ammonium bisulfate solutions.

In some embodiments of the present invention, a solid-liquid ratio of the carbon black powder to the ammonium salt solution is 10-500 g/L; further, the solid-liquid ratio of the carbon black powder to the ammonium salt solution is 50-200 g/L.

In some embodiments of the present invention, a mass concentration of the ammonium salt solution is 0.1%-30%; further, the mass concentration of the ammonium salt solution is 1%-10%.

In some embodiments of the present invention, in step S1, a temperature for the hydrothermal reaction is 100-400° C.; preferably, time for the hydrothermal reaction is 1-10 h.

In some embodiments of the present invention, in step S1, the sodium salt is one or more of sodium acetate, sodium hydroxide, sodium sulfate, sodium phosphate, sodium chloride, sodium nitrate, sodium oxalate, sodium citrate, sodium manganate or sodium carbonate.

In some embodiments of the present invention, in step S1, the average particle size of the mixture is less than 100 μm.

In some embodiments of the present invention, in step S1, the acid is one or more of sulfuric acid, nitric acid, phosphoric acid or hydrochloric acid; further, a concentration of the acid is 0.1-5 mol/L.

In some embodiments of the present invention, in step S1, the nickel-cobalt-manganese mixed salt is prepared by battery recycling; preferably, the mass ratio of the sodium salt to the nickel-cobalt-manganese mixed salt is (1-10):(0.1-30).

In some embodiments of the present invention, in step S1, the organic acid solution is one or more of oxalic acid, citric acid, acetic acid, formic acid, or acetic acid solution; a solid-liquid ratio of the mixture to the organic acid solution is 10:(50-200) g/mL; further, a mass concentration of the organic acid solution is 1%-40%.

In some embodiments of the present invention, in step S1, a temperature for the heating reaction is 300-1100° C.; preferably, time for the heating reaction is 2-24 h.

In some embodiments of the present invention, in step S2, the binding agent is one or more of calcium silicate, calcium alginate, clay silicate or sodium aluminosilicate; preferably, a mass ratio of the nickel-cobalt-manganese-sodium mixed salt, to the ammonium salt modified carbon black, and to the binder is (10-50):(30-70):(0.1-8).

In some embodiments of the present invention, in step S2, the heating temperature is 300-800° C.; further, the heating time is 2-24 h.

In some embodiments of the present invention, in step S2, the density after compaction is more than 1.8 g/cm³.

The present invention also provides a wastewater adsorbent, which is prepared by the preparation method.

The present invention also provides use of the wastewater adsorbent in the treatment of ternary precursor wastewater.

In some embodiments of the present invention, the method for treating ternary precursor wastewater comprises: settling, filtering and strongly oxidizing the ternary precursor wastewater to obtain primary treated wastewater, and adding the wastewater adsorbent to the primary treated wastewater for adsorption treatment, soaking the wastewater adsorbent after treatment in an acid for desorption, after adsorption-desorption treatments for 2-6 times, sending the treated wastewater to secondary treatment, and reusing the wastewater adsorbent for adsorption treatment again. It should be noted that the ternary precursor wastewater is the wastewater produced by acid leaching, precipitation and impurity removal, extraction and separation, alkali addition, ammonia addition, and aging in the ternary precursor production process.

In some embodiments of the present invention, a solid-liquid ratio of the wastewater adsorbent to the primary treated wastewater is (0.5-20):(30-200) kg/L.

In some embodiments of the present invention, the acid used for the soaking and desorption is one or more of sulfuric acid, nitric acid, phosphoric acid or hydrochloric acid, and its concentration is further 0.01-3 mol/L.

According to a preferred embodiment of the present invention, it has at least the following beneficial effects.

1. The wastewater adsorbent of the present invention has high stability and various adsorption options. After the carbon black powder in the wastewater adsorbent is modified by ammonium salt through hydrothermal method, the polarity and acid-base properties of the carbon black powder are greatly changed, and the adsorption performance to the ammonium radical is enhanced. In the nickel-cobalt-manganese mixed salt, manganese salt is the main material of the adsorbent polymetallic salt. Adding cobalt salt/nickel salt to strengthen the stability of the adsorbent, using carbon black powder as the base material of the adsorbent, and heating to synthesize the polymetal-carbon-based adsorbent, can further strengthen the inherent excellent performance of porous carbon in carbon black powder, improve its surface properties, help enhance the interaction between the adsorbent and ions, and improve the adsorption performance. The multi-metal-carbon-based adsorbent prepared in the present invention has specific adsorption capacity for sodium, ammonium radical, and sulfate radical. As a base carbon material, carbon black powder can simultaneously adsorb calcium, iron, manganese, cobalt and many other ions. It has diversified adsorption. Moreover, the adsorbent can be reused after desorption treatment, and it has the ability of repetitive adsorption.

2. Using the method of the present invention, the production cost is significantly reduced. On the one hand, the raw material source of the polymetal-carbon-based adsorbent synthesized by the invention can be the product recovered from the waste battery, in which the carbon black powder can come from an anode material of the waste battery, and the nickel-cobalt-manganese-sodium mixed salt can come from a cathode material of the waste battery. Therefore, the main materials of the adsorbent are originated from the secondary utilization of the waste material. On the other hand, the adsorbent synthesized by the present invention can be reused. After the primary treated wastewater is adsorbed, the adsorbent can be placed in an acid for desorption treatment and reused. Therefore, the recycling of the material in the present invention is high.

### BRIEF DESCRIPTION OF DRAWINGS

The present invention will be further described below in conjunction with the accompanying drawings and examples, in which:

FIG. 1 is a process flow diagram of Example 1 of the present invention; and

FIG. 2 is an SEM image of the wastewater adsorbent prepared in Example 2 of the present invention.

### DETAILED DESCRIPTION

Hereinafter, the concept and the produced technical effects of the present invention will be described clearly and completely in combination with the examples, so as to fully understand the purpose, features and effects of the present invention. Obviously, the described examples are only a part of the examples of the present invention, rather than all of them. Based on the examples of the present invention, other examples obtained by those skilled in the art without creative work belong to the scope of protection of the present invention.

### Example 1

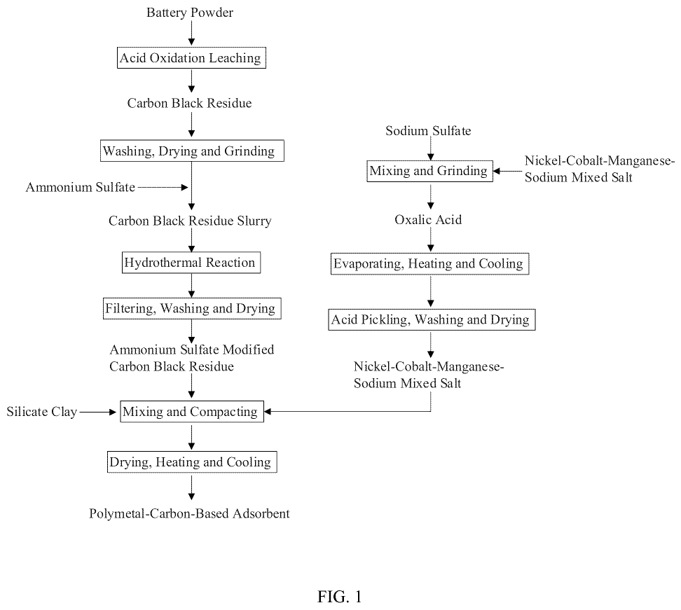

A preparation method for wastewater adsorbent and wastewater treatment method were provided. Referring to FIG. 1, the specific process was:

(1) Carbon black residue modification: the battery powder recovered from lithium battery was subjected to acid oxidation leaching to obtain carbon black residue. The carbon black residue was washed, dried, and ground to an average particle size of less than 0.1 mm to obtain carbon black residue powder. 34 g carbon black residue powder was mixed with 200 mL 3.3% ammonium sulfate solution and stirred to obtain carbon black residue slurry. The carbon black residue slurry was sent to a closed container for heating, and hydrothermally reacted at 160° C. for 3 h and 3 min; after cooling, filtered, the filter residue was washed with dilute acid and dried to obtain ammonium sulfate modified carbon black residue.

(2) Preparation of nickel-cobalt-manganese-sodium mixed salt: the nickel-cobalt-manganese mixed salt prepared by battery recovery was mixed with sodium sulfate and ground to an average particle size of less than 100 μm to obtain a mixture. The mixture was uniformly mixed with 6.12 w % oxalic acid solution, subjected to solid-liquid separation, and evaporated to remove water, heated at 430° C. under an inert atmosphere, kept at a constant temperature for 3 h and 44 min, and cooled down. 0.34 mol/L hydrochloric acid was added for acid pickling, washed, and dried to obtain nickel-cobalt-manganese-sodium mixed salt.

Wherein, the mass ratio of sodium sulfate to the nickel-cobalt-manganese mixed salt=3:12, and the solid-liquid ratio of the mixture to the oxalic acid solution is 10:50 g/mL.

(3) Synthesis of polymetal-carbon-based adsorbent: 15.8 g of nickel-cobalt-manganese-sodium mixed salt, 34 g of ammonium sulfate modified carbon black residue, and 5 g of silicate clay were mixed and compacted to obtain a certain flake shape with a compaction density of 2.53 g/cm³, which was dried, heated at 485° C. in a nitrogen atmosphere, kept at a constant temperature for 2 h and 12 min, and cooled down to obtain a polymetal-carbon-based adsorbent.

(4) Wastewater treatment by adsorbent adsorption: the wastewater produced by the preparation of the ternary precursor was settled, filtered, and strongly oxidized to obtain the primary treated wastewater, and the multi-metal-carbon-based adsorbent was added for adsorption treatment. The adsorbent after treatment was soaked in 0.34 mol/L hydrochloric acid for desorption, after adsorption-desorption treatment for 5 times, the treated wastewater was sent to the secondary treatment, and the adsorbent was reused for adsorption treatment again.

Wherein, the solid-liquid ratio of adsorbent to wastewater was 1:13 g/mL.

### Example 2

A preparation method for wastewater adsorbent and wastewater treatment method were provided, and the specific process was:

(1) Carbon black residue modification: the battery powder recovered from the lithium battery was subjected to acid oxidation leaching to obtain carbon black residue. The carbon black residue was washed, dried, and ground to an average particle size of less than 0.1 mm to obtain carbon black residue powder. 45 g carbon black residue powder was mixed with 280 mL 3.7% ammonium sulfate solution and stirred to obtain carbon black residue slurry. The carbon black residue slurry was sent to a closed container for heating, and hydrothermally reacted at 185° C. for 2 h and 13 min, after cooling, filtered, the filter residue was washed with dilute acid and dried to obtain ammonium sulfate modified carbon black residue.

(2) Preparation of nickel-cobalt-manganese-sodium mixed salt: the nickel-cobalt-manganese mixed salt prepared by battery recovery was mixed with sodium sulfate and ground to an average particle size of less than 100 μm to obtain a mixture. The mixture was uniformly mixed with 3.41 w % oxalic acid solution, subjected to solid-liquid separation, and evaporated to remove water, heated at 425° C. under an inert atmosphere, kept at constant temperature for 3 h and 54 min, cooled down, 0.34 mol/L hydrochloric acid was added for acid pickling, washed, and dried to obtain nickel-cobalt-manganese-sodium mixed salt.

Wherein, the mass ratio of sodium sulfate to the nickel-cobalt-manganese mixed salt=5:17, and the solid-liquid ratio of the mixture to the oxalic acid solution was 10:65 g/mL.

(3) Synthesis of polymetal-carbon-based adsorbent: 22 g of nickel-cobalt-manganese-sodium mixed salt, 45 g of ammonium sulfate modified carbon black residue, and 7 g of silicate clay were mixed and compacted to obtain a certain flake shape with a compaction density of 2.23 g/cm³, which was dried, heated at 485° C. in a nitrogen atmosphere, kept at constant temperature for 2 h and 12 min, and cooled down to obtain a polymetal-carbon-based adsorbent.

Wherein, the mass ratio of nickel-cobalt-manganese-sodium mixed salt, to ammonium sulfate modified carbon black residue, and to silicate clay=35:70:2.3.

(4) Wastewater treatment by adsorbent adsorption: the wastewater produced by the preparation of the ternary precursor was settled, filtered, and strongly oxidized to obtain the primary treated wastewater, and the multi-metal-carbon-based adsorbent was added for adsorption treatment. The adsorbent after treatment was soaked in 0.34 mol/L hydrochloric acid for desorption, after adsorption-desorption treatment for 5 times, the treated wastewater was sent to the secondary treatment, and the adsorbent was reused for adsorption treatment again.

Wherein, the solid-liquid ratio of adsorbent to wastewater was 1:9 kg/L.

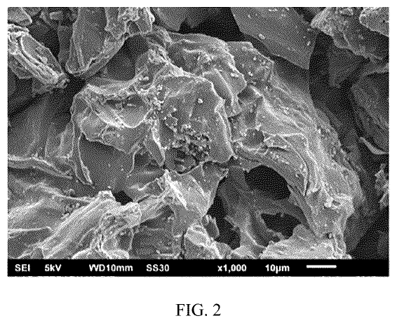

FIG. 2 was an SEM image of the wastewater adsorbent prepared in this example. It can be seen from the figure that the adsorbent had a structure with a rough surface and pores inside.

### Example 3

A preparation method for wastewater adsorbent and wastewater treatment method were provided, and the specific process was:

(1) Carbon black residue modification: the battery powder recovered from the lithium battery was subjected to acid oxidation leaching to obtain carbon black residue. The carbon black residue was washed, dried, and ground to an average particle size of less than 0.1 mm to obtain carbon black residue powder. 36 g carbon black residue powder was mixed with 240 mL of 4.4% ammonium chloride solution and stirred to obtain carbon black residue slurry. The carbon black residue slurry was sent to a closed container for heating, and hydrothermally reacted at 160° C. for 2 h and 33 min, after cooling, filtered, the filter residue was washed with dilute acid and dried to obtain ammonium chloride modified carbon black residue.

(2) Preparation of nickel-cobalt-manganese-sodium mixed salt: the nickel-cobalt-manganese mixed salt prepared by battery recovery was mixed with sodium sulfate and ground to an average particle size of less than 100 μm to obtain a mixture. The mixture was uniformly mixed with 6.33 w % oxalic acid solution, subjected to solid-liquid separation, and evaporated to remove water, heated at 430° C. under an inert atmosphere, kept at a constant temperature for 3 h and 34 min, cooled down, 0.34 mol/L hydrochloric acid was added for acid pickling, washed, and dried to obtain nickel-cobalt-manganese-sodium mixed salt.

Wherein, the mass ratio of sodium sulfate to the nickel-cobalt-manganese mixed salt=4:13, and the solid-liquid ratio of the mixture to the oxalic acid solution was 10:50 g/mL.

(3) Synthesis of multi-metal-carbon-based adsorbent: 17 g of nickel-cobalt-manganese-sodium mixed salt, 36 g of ammonium chloride modified carbon black residue, and 5 g of silicate clay were mixed and compacted to obtain a certain block shape with a compaction density of 2.07 g/cm³, which was dried, heated at 485° C. in a nitrogen atmosphere, kept at constant temperature for 2 h and 12 min, and cooled down to obtain a polymetal-carbon-based adsorbent.

(4) Wastewater treatment by adsorbent adsorption: the wastewater produced by the preparation of the ternary precursor was settled, filtered, and strongly oxidized to obtain the primary treated wastewater, and the multi-metal-carbon-based adsorbent was added for adsorption treatment. The adsorbent after treatment was soaked in 0.34 mol/L hydrochloric acid for desorption, after adsorption-desorption treatment for 5 times, the treated wastewater was sent to the secondary treatment, and the adsorbent was reused for adsorption treatment again.

Wherein, the solid-liquid ratio of adsorbent to wastewater was 1:7 kg/L.

### Example 4

A preparation method for wastewater adsorbent and wastewater treatment method were provided, and the specific process was:

(1) Carbon black residue modification: the battery powder recovered from the lithium battery was subjected to acid oxidation leaching to obtain carbon black residue. The carbon black residue was washed, dried, and ground to an average particle size of less than 0.1 mm to obtain carbon black residue powder. 25 g carbon black residue powder was mixed with 200 mL of 5.3% ammonium chloride solution and stirred to obtain carbon black residue slurry. The carbon black residue slurry was sent to a closed container for heating, and hydrothermally reacted at 160° C. for 3 h and 8 min, after cooling, filtered, the filter residue was washed with dilute acid and dried to obtain ammonium chloride modified carbon black residue.

(2) Preparation of nickel-cobalt-manganese sodium mixed salt: the nickel-cobalt-manganese mixed salt prepared by battery recovery was mixed with sodium sulfate and ground to an average particle size of less than 100 μm to obtain a mixture. The mixture was uniformly mixed with 6.12 w % oxalic acid solution, subjected to solid-liquid separation, and evaporated to remove water, heated at 430° C. under inert atmosphere, kept at a constant temperature for 3 h and 17 min, cooled down, 0.34 mol/L hydrochloric acid was added for acid pickling, washed, and dried to obtain nickel-cobalt-manganese-sodium mixed salt.

Wherein, the mass ratio of sodium sulfate to the nickel-cobalt-manganese mixed salt=5:15, and the solid-liquid ratio of the mixture to the oxalic acid solution was 10:50 g/mL.

(3) Synthesis of polymetal-carbon-based adsorbent: 8 g of nickel-cobalt-manganese-sodium mixed salt, 25 g of ammonium chloride modified carbon black residue, and 3 g of silicate clay were mixed and compacted to obtain a certain block shape with a compaction density of 2.47 g/cm³, which was dried, heated at 485° C. under a nitrogen atmosphere, kept at a constant temperature for 2 h and 12 min, and cooled down to obtain a polymetal-carbon-based adsorbent.

(4) Wastewater treatment by adsorbent adsorption: the wastewater produced by the preparation of the ternary precursor was settled, filtered, and strongly oxidized to obtain the primary treated wastewater, and the multi-metal-carbon-based adsorbent was added for adsorption treatment. The adsorbent after treatment was soaked in 0.34 mol/L hydrochloric acid for desorption, after adsorption-desorption treatment for 5 times, the treated wastewater was sent to the secondary treatment, and the adsorbent was reused for adsorption treatment again.

Wherein, the solid-liquid ratio of adsorbent to wastewater was 1:10 g/L.

### Comparative Example 1

The difference between this comparative example and Example 1 is that the carbon black residue in step (1) is not modified.

### Comparative Example 2

The difference between this comparative example and Example 1 was that the nickel-cobalt-manganese-sodium mixed salt was not added in step (3).

### Comparative Example 3

The difference between this comparative example and Example 3 was that the nickel-cobalt-manganese-sodium mixed salt was not added in step (3).

TABLE 1
The impurity content of wastewater before and after adsorption
treatment of Examples 1-4 and Comparative Examples 1-3.

| | | | | | | total | total |
|---|---|---|---|---|---|---|---|
| | | Ni | Fe | Na | Ca | nitrogen | phosphorus |
| Item | | (mg/L) | (mg/L) | (mg/L) | (mg/L) | (mg/L) | (mg/L) |
| Example 1 | before | 145.7 | 486 | 2634 | 778 | 3566 | 387 |
| | adsorption | | | | | | |
| | after | 66.3 | 132 | 371 | 298 | 768 | 49 |
| | adsorption | | | | | | |
| Example 2 | before | 173.4 | 450 | 2431 | 763 | 3323 | 344 |
| | adsorption | | | | | | |
| | after | 51.8 | 107 | 325 | 268 | 413 | 38.4 |
| | adsorption | | | | | | |
| Example 3 | before | 155.3 | 631 | 3157 | 831 | 3978 | 396 |
| | adsorption | | | | | | |
| | after | 70.9 | 78 | 323 | 325 | 743 | 54.7 |
| | adsorption | | | | | | |
| Example 4 | before | 164.5 | 539 | 2568 | 764 | 3516 | 354 |
| | adsorption | | | | | | |
| | after | 54.0 | 32 | 344 | 274 | 935 | 73.3 |
| | adsorption | | | | | | |
| Comparative | before | 147.6 | 472 | 2544 | 770 | 3480 | 383 |
| Example 1 | adsorption | | | | | | |
| | after | 93.5 | 177 | 383 | 356 | 1156 | 81.6 |
| | adsorption | | | | | | |
| Comparative | before | 143.1 | 482 | 2643 | 815 | 3398 | 302 |
| Example 2 | adsorption | | | | | | |
| | after | 111.7 | 156 | 554 | 372 | 934 | 77.5 |
| | adsorption | | | | | | |
| Comparative | before | 153.3 | 636 | 3176 | 863 | 3824 | 387 |
| Example 3 | adsorption | | | | | | |
| | after | 118.6 | 174 | 638 | 396 | 928 | 68.3 |
| | adsorption | | | | | | |

It can be seen from Table 1 that compared with Comparative Example 1, the removal of ammonia nitrogen in the wastewater of Examples 1˜4 after ammonium salt modification was significantly improved. On the other hand, compared with Comparative Examples 2 and 3, after the nickel-cobalt-manganese-sodium mixed salt was added, the removal of nickel and sodium in the wastewater was significantly improved in Examples 1-4.

The examples of the present invention are described in detail above with reference to the accompanying drawings. However, the present invention is not limited to the above-mentioned examples. Within the scope of knowledge possessed by those of ordinary skilled in the art, various modifications can be made without departing from the purpose of the present invention. In addition, the examples of the present invention and the features in the examples can be combined with each other on the condition of no conflict.

1. A preparation method for a wastewater adsorbent, comprising the following steps:
S1: mixing carbon black powder with ammonium salt solution, heating for hydrothermal reaction, and then filtering, washing the resulting filter residue with acid to obtain ammonium salt modified carbon black; mixing and grinding nickel-cobalt-manganese mixed salt and sodium salt to obtain a mixture, mixing the mixture with an organic acid solution, evaporating to remove water, and performing heating reaction in an inert atmosphere; and acid washing a material after the reaction to obtain nickel-cobalt-manganese-sodium mixed salt; and
S2: mixing the nickel-cobalt-manganese-sodium mixed salt, ammonium salt modified carbon black and a binding agent, compacting, drying and heating to obtain a multi-metal-carbon-based adsorbent.

2. The preparation method according to claim 1, wherein in step S1, the carbon black powder is obtained by acid oxidation leaching of battery powder recovered from a lithium battery.

3. The preparation method according to claim 1, wherein in step S1, the ammonium salt solution is one or more of ammonium sulfate, ammonium bisulfate, ammonium carbonate, ammonium bicarbonate, ammonium chloride, ammonium phosphate or ammonium dihydrogen phosphate solutions; and the solid-liquid ratio of the carbon black powder to the ammonium salt solution is 10-500 g/L, and the mass concentration of the ammonium salt solution is 0.1%-30%.

4. The preparation method according to claim 1, wherein in step S1, a temperature for the hydrothermal reaction is 100-400° C.; preferably, time for the hydrothermal reaction is 1-10 h.

5. The preparation method according to claim 1, wherein in step S1, the nickel-cobalt-manganese mixed salt is prepared by battery recovery; preferably, the mass ratio of the sodium salt and the nickel-cobalt-manganese mixed salt is (1-10):(0.1-30).

6. The preparation method according to claim 1, wherein in step S1, the organic acid solution is one or more of oxalic acid, citric acid, acetic acid, formic acid, or acetic acid solution; and the solid-liquid ratio of the mixture and to the organic acid solution is 10:(50-200) g/mL, and the mass concentration of the organic acid solution is 1%-40%.

7. The preparation method according to claim 1, wherein in step S1, a temperature for the heating reaction is 300-1100° C.; preferably, time for the heating reaction is 2-24 h.

8. The preparation method according to claim 1, wherein in step S2, the binding agent is one or more of calcium silicate, calcium alginate, clay silicate or sodium aluminosilicate; preferably, a mass ratio of the nickel-cobalt-manganese-sodium mixed salt, to the ammonium salt modified carbon black, and to the binder is (10-50):(30-70):(0.1-8).

9. A wastewater adsorbent, prepared by the preparation method of claim 1.

10. Use of the wastewater adsorbent of claim 9 in the treatment of ternary precursor wastewater.

11. A wastewater adsorbent, prepared by the preparation method of claim 2.

12. A wastewater adsorbent, prepared by the preparation method of claim 3.

13. A wastewater adsorbent, prepared by the preparation method of claim 4.

14. A wastewater adsorbent, prepared by the preparation method of claim 5.

15. A wastewater adsorbent, prepared by the preparation method of claim 6.

16. A wastewater adsorbent, prepared by the preparation method of claim 7.

17. A wastewater adsorbent, prepared by the preparation method of claim 8.
